(19) United States
(12) Patent Application Publication
(10) Pub. No.: US 2004/0013376 A1
(43) Pub. Date: Jan. 22, 2004

(54) Dielectric particles in optical waveguides for improved performance

(75) Inventor: David G. Mikolas, Rowland Heights, CA (US)

Correspondence Address: Phyllis Turner-Brim, Cabot Microelectronics Corp., 870 Commons Drive, Aurora, IL, 60504, US

(73) Assignee: Cabot Microelectronics Corp.

(21) Appl. No.: 10/196,406

(22) Filed: Jul. 16, 2002

(51) Int. Cl. G02B 6/02

(52) U.S. Cl. 385/123

(57) ABSTRACT

A multimode optical waveguide having reduced modal dispersion. The optical waveguide comprises a core, a cladding surrounding the core, and a plurality of optical scattering elements dispersed in the core.

### BACKGROUND OF THE INVENTION

1. Field of the Invention

This invention relates to multi-mode optical waveguides having reduced modal dispersion.

2. Description of the Related Art

Optical waveguides, such as optical fibers, consist of two basic components; a core and a cladding layer. A protective layer can cover the cladding and the core. The protective layer adds mechanical strength to the fiber to prevent cracking and breaking. Generally, the core has a higher index of refraction than the cladding thereby confining light in the core with minimal loss of intensity into the cladding. This phenomenon is sometimes referred to as total internal reflection.

There are two well-known types of optical fibers, with distinctive properties. These are single mode fibers (SMF) and multi-mode fibers (MMF). Single-mode fibers have small core diameters, typically 2 to 10 wavelengths, and confine the propagating light to a single optical mode. Multi-mode optical fibers have a relatively large core diameter (20 to 100 wavelengths for communications, but otherwise no upper limit) and allow light to propagate in a large number of modes while still being confined to the fiber core.

Multi-mode optical fibers are predominantly manufactured with two kinds of core structures; a step index and a graded index (SI-MMF and GI-MMF). In SI-MMF, the core is made of a homogeneous material with a uniform index of refraction. This type of uniform core is highly susceptible to modal dispersion (MD) with higher order modes propagating more slowly than lower order modes. As a result, SI-MMF fibers have been limited to low bandwidth and short distance applications. The large MD of SI-MMF fibers can result in a range of typically about 10% or more in propagation velocity among all of the confined modes.

The core of a GI-MMF, on the other hand, has a refractive index profile which is peaked at the center and decrease with radius with an approximately parabolic profile, which results in a focusing of the light. This focusing effect can be described as providing a constant propagation velocity for all of the confined modes and therefore a dramatic reduction in modal dispersion which can be as low as 10 parts per billion or less. Any residual MD in GI-MMF is due to manufacturing realities. A perfect index of refraction profile for a GI-MMF, ignoring other effects, should theoretically result in zero MD.

Polymer optical fiber (POF) has not traditionally been used for high-speed data transmission over significant distances, and thus has been typically manufactured as SI core only. In addition, the polymer material of the core (and to some extent the cladding) exhibit very high attenuation when compared to silica-based materials (100 to greater than 1000 dB/km for POF but less as low as 0.2 dB in silica based materials, in the near-infrared) because of absorption by the organic bonds in the fiber core. Recently, improved manufacturing techniques have produced extremely high quality, graded-index, multi-mode polymer optical fiber (GI-POF) which has similar high-speed data carrying capacity as glass core multi-mode fiber. Careful formulation of the polymer, including complete replacement of hydrogen by fluorine (perfluorinated polymers) has reduced absorption to about 20 dB/km in the yellow-red region of the visible spectrum (500-600 nanometers).

The recurrent problem with multi-mode waveguides, whether silica, or plastic, step-index or graded index is the phenomenon of MD, as discussed above. MD is one effect that limits the rate at which a series of optical pulses can be transmitted through a given length optical fiber, and still be recognizable as individual pulses at the end, and also to be convertible into electronic digital signals with an acceptably low rate of errors or bit error rate (BER).

There exists a need, therefore, for optical waveguides having reduced modal dispersion. Reduced modal dispersion permits a waveguide to transport pulses spaced closer together in time without unacceptable spreading and increase in BER, thus allowing the fiber to support larger bandwidth.

### SUMMARY OF THE INVENTION

This invention relates to multi-mode optical waveguides having reduced modal dispersion. The invention also relates to methods of reducing modal dispersion in multi-mode optical waveguides.

Accordingly, this invention provides an optical waveguide having reduced modal dispersion comprising a core, a cladding layer surrounding the core, and a plurality of optical scattering elements dispersed in the core.

### BRIEF DESCRIPTION OF THE DRAWINGS

FIG. 1 is a schematic diagram of an optical fiber having optical scattering elements in a continuously varying distribution in the fiber core.

FIG. 2 is a schematic diagram of an optical fiber having optical scattering elements concentrated near the edge of the core.

FIG. 3 is a schematic diagram of an optical fiber having optical scattering elements concentrated near the center of the core.

### DESCRIPTION OF THE CURRENT EMBODIMENT

Dispersion plays an important role in the ultimate performance of optical waveguides. There are two predominant types of dispersion: chromatic dispersion, and modal dispersion. Chromatic dispersion is the variation in the velocity of light traveling within a waveguide with changes in optical frequency. An optical data pulse traveling through a waveguide always contains a spectrum of frequencies which typically travel at different speeds. Thus, some frequency components arrive at the output earlier than others. The difference in arrival times of the various frequencies in the pulse results in distortion of the signal in the time domain and therefore broadening of the pulse. The broadened pulse is susceptible to errors when converted into a digital signal.

Modal dispersion (MD) is the measure of the difference in arrival times of parts of a single optical signal which is distributed among the various confined modes of an MMF. In the case of SI-MMF, higher order modes travel substantially slower than those of lower order, but in the case of GI-MMF, the MD is primarily due to errors in manufacturing such as departure from the target GI profile and small fluctuations in core diameter. The behavior of MD with mode order is not monotonic and predictable a priori. The difference in arrival time of the components of an optical signal traveling in different modes places a limit on the maximum bandwidth that can be supported by a given length of MMF.

This invention provides methods and devices for significantly reducing the effect of modal dispersion on the spread in arrival time of optical signals traveling in multimode waveguides. Specifically, the invention provides waveguides containing optical scattering elements for scattering light from one mode to another as it propagates through a waveguide, thus allowing the light to sample different modes. As a result of the scattering, the light is exchanged between a number of different modes with different propagation velocities as it travels from one end of the fiber to the other which results in an averaging effect in propagation velocity. Light that otherwise travels only in the slowest mode spends a significant time in faster modes, and likewise light in the fastest modes spends a significant time in the slower modes. When the light is in the form of an optical signal, the overall effect is a narrowing in arrival times of the components of the optical pulse.

This narrowing of arrival times can be referred to as a reduction in “effective modal dispersion.” This is because the dispersions of the modes of the fiber have not been altered, but instead the modes are mixed by a series of discrete scattering events, allowing a given signal to spend time in a number of modes with a distribution in modal dispersions. This results in a statistical sampling of the modal dispersions. In a very simple model, the resulting spread in time would be reduced by a factor roughly proportional to 1/N^{1/2} where N is the number of scattering events.

Modal mixing in the invention is produced by the introduction of light scattering elements into the core of an optical waveguide, as disclosed herein.

Modal mixing by scattering elements, as described herein, can also be used to either enhance a modal population state or depopulate an established modal state. For example, concentration of the scattering elements of the invention at the periphery of the core results in the selective depopulation of the higher order modes which are either scattered into lower order modes or are scattered out of the core. Similarly, concentrating the scattering elements at the center of the core selectively depopulates lower order modes either to higher order modes or out of the core.

The ability to scatter light out of the core can also be used to permit remote sampling of signals as they travel through, for example, an optical fiber. Thus, certain regions along the length of the fiber can be seeded with a high concentration of optical scattering elements which results in some out-scattering of the optical signal. If a given average concentration of scattering elements is already required for other purposes such as reduction in effective MD, they can be concentrated in these regions as an additional benefit.

For simplicity, the invention is generally described in terms of optical fibers, but it is to be understood that the invention is applicable to all types of multimode waveguides such as multimode planar waveguides, thin film waveguides, and optical fibers. Waveguides can be, for example, silica based waveguides, polymer based waveguides, or other types of fabricated or fiber waveguides, each of which can have step-index or graded-index structure. Waveguides of the invention can also be multimodal in either one or both transverse directions. Applications of MM waveguides with reduced effective MD beyond optical fibers include local optical interconnect of high-speed data such as backplane interconnects, multi-chip module (MCM) interconnects and clock-distribution.

The invention is not limited to specific wavelengths of light and is applicable to all electromagnetic radiation, including millimeter and microwave waveguides.

Optical Scattering Elements

The optical scattering elements of the invention can be any type of structure or element that scatters, induces scattering, or redirects light or an optical signal as it propagates through a waveguide.

Generally, any structure that is of different refractive index than the surrounding core material will have a redirecting effect on light that encounters it. Such elements include, for example, one or more dielectric particles, elongated structures, imperfections, or gas bubbles, and combinations thereof, located at least partly in the core of the waveguide. Preferred scattering elements are dielectric particles.

The dielectric particles will preferably have a refractive index that differs from the surrounding medium by about ±0.005 to about ±1. For particles that are very small in cross section compared to a wavelength, including long but thin (elongated) particles, the difference in index of refraction with respect to the surrounding medium is preferably ±0.1 to ±1.0. For particles having a size on the order of a wavelength or larger, it is preferable that the difference in index be ±0.005 to ±0.05. It is not required that all the particles used in the core have the same refractive index. In fact, mixtures of high and low refractive index materials can allow tuning of the index. Further, the mixtures can be homogeneously distributed or in sub-wavelength segregated regions, each region providing a different resulting effective index.

Alternatively, the particles can have the same or essentially the same refractive index as the core or medium. Such particles, when used with a graded index fiber, result in perturbation of the otherwise circularly uniform graded index of the fiber. The scattering effect is thus the induced deviation in the graded profile by the element, and not the element itself.

The dielectric particles of the invention can possess a variety of shapes and sizes, including essentially spherical shapes, filament shapes, string shapes, nonuniform shapes, elongated structures, or combinations thereof. The particles can be present in the waveguide as discrete structures or as groups of particles, including dimers, linear clusters, non-linear clusters including regular and irregular shapes. If the particles are of approximately equal size and arranged as an approximately linear chain, they can act as diffraction gratings and scatter light such that the angular distribution in scattering is strongly peaked away from the forward direction. This is one means of selectively mixing a certain group of modes, or insuring that all scattering events result in scattering out of the core and into a specific angular distribution within the cladding.

Dielectric particles of the invention can be made of a variety of materials, including organic materials, inorganic materials or mixtures thereof. Particles are chosen primarily based on their index of refraction, their ability to hold dopants such as luminescent compounds (see below), and their melting point, Tg, or thermal stability (also discussed below).

Examples of inorganic materials include, but are not limited to, SiO₂, TiO₂, Al₂O₃, ZrO₂, HfO₂, Er₂O₃, Y₂O₃, Bi₂O₃, CaF₂, CeF₃, Cr₂O₃, Gd₂O₃, LaF₃, MgF₂, Na₃AlF₆, Sb₂O₃, SrF₂, Ta₂O₅, YbF₃, ZnSe, and mixtures thereof, and glass such as borosilicate glass or other types of glass. Preferred inorganic particles are SiO₂, TiO₂ and glass. Examples of organic particulate materials include, but are not limited to, particles of polymethylmethacrylate (PMMA) and its derivatives, polyester, polyimide, polystyrene, and polypropylene particles.

The particles of the invention can be composed of or can contain a photochromic compound. These particles can be used to change the refractive index of the particles while in the core, and thus the strength of their scattering. The index difference between the particle and the surrounding medium can be controlled by external illumination that is cladding coupled or that is co-confined to the core. Suitable photochromic compounds include both organic and inorganic compounds. These types of materials include, but are not limited to, spiropyrans, spirooxazines, chromenes, fulgides and fulgimides, diarylethenes, spirodihydroindolizines, azo compounds, polycyclic aromatic compounds, anils and related compounds, polycyclic quinones, (periaryloxyquinones), perimidnespirocyclohexadienones, viologens, and triarylmethanes, as well as naturally occurring biological molecules such as rhodopsins and phytochromes, and inorganic halides such silver chloride and silver bromide. Organic photochromic materials are preferably doped into polymer hosts at a weight ratio of up to about 50% before introduction into the core. Suitable polymer hosts include polymehthylmethacrlylate (PMMA) polycarbonate, polystyrene, polyvinyl chlorides and bromides (PVC, PVB), polypropylene, urethanes and acrylics.

The particles of the invention can also be made of or contain photorefractive materials. These types of particles have an index of refraction that can be permanently changed by exposure to light, such as ultraviolet light. Photorefractive materials are suited to situations where continuous optical induction of a photochromic material is undesirable, costly, or not necessary. Thus, the photorefractive particles can be index-matched to the core material and therefore have no effect in their un-activated state. A one-time exposure either through the fiber, or external exposure sideways through the cladding can activate scattering material in a section of fiber in order to optimize performance in a particular installation. Photorefractive particles used in the invention can be organic or inorganic.

With organic particles, the high energy of UV photons (>3 eV at 365 nanometers) can induce a large number of bond-breaking and molecular conformational changes in the organic molecules which can induce a change in absorption and index of refraction, at the data transmission wavelength of the fiber. Those experienced in the art will recognize that there will be a very large variety of organic molecules which can be engineered with the proper characteristics and included in otherwise index-matched particles for a given application. Cross-linking of polymer chains can also be induced by UV radiation.

With inorganic particles, a useful technique for producing refractive index changes in silica-based optical fiber cores is illumination with ultraviolet light. For exposures around 248 nanometer wavelengths (KrF laser), silica doped with germanium oxide will include oxygen deficient germanium molecules. These have a strong absorption peak around this wavelength, resulting in a rearrangement of the bonds and a local compaction and an increase in index of refraction.

Because the dielectric particles of the invention are introduced into the core during manufacture of the waveguide, one factor that is considered in choosing the particles is the decomposition temperature of the particles relative to the waveguide's processing temperature. If the core is made out of glass, the dielectric particles are preferably an inorganic material which can withstand, without decomposing, the high processing temperatures required for manufacturing the glass core. In some cases however, decomposition into components that form gas bubbles, or which dissolve or interdiffuse into the glass or polymer material is desirable to achieve a specific scattering property. If the core of the waveguide is a polymer, as in a polymer optical fiber, then the dielectric particles can be either organic or inorganic or mixtures thereof.

Another important factor to consider in the choice of particles and that is related to their final shape is the particles' glass transition temperature (Tg) relative to the core material's processing temperature during manufacture. A glass phase transition allows the behavior of the viscosity of the particle with respect to temperature to be controlled so that a given amount of elongation of the particle occurs during the fiber drawing. For essentially spherical discrete particles in the final product, the Tg of the particles should be higher than the temperature at which the core is drawn.

For particles with viscosity matched to the core material, the resulting particle will be longer than the diameter of the original particle, and will also have a cross-sectional area smaller than the cross-sectional area of the particle by a ratio equal to the ratio between the initial diameter of the core perform and the final core diameter. The viscosity of the particle during the drawing of the core also has an impact on the uniformity of the GI profile in a GI-MMF. Particles can cause lumpiness in the viscosity, ranging from hard spheres which significantly distort the GI profile locally, to viscosity-matched glass which allows the core to be pulled without significant impact on the GI profile.

The physical and geometric properties of the particles can also be adjusted by other attributes such as the melting temperature of the particles and the solubility or diffusion rate of the particle into the surrounding medium.

Thus, the particles can have a discrete phase change and melt in the core material at some point in time associated with the fiber draw. Under these circumstances, the particles and core materials are inter-diffused or one is soluble in the other. By providing a larger particle with a smaller index change, or even one with more diffuse edges rather than hard edges, the scattering properties and therefore the nature of the modal mixing properties can be optimized.

The chemical composition and methods of preparation of the particles affects several of the particles' optical properties. One such optical property is scattering angle distribution of light caused by the particles as the light encounters the particles while propagating through the core.

Scattering angle distribution is affected by various particle properties including the size or diameter of the particle. If the average scattering angle is larger than the critical angle required for total internal reflection, then the light will at least partly scatter out of the core. The more the light is scattered out of the core, the greater the attenuation of the signal. Generally, for an approximately spherical particle, the smaller the particle the larger the average scattering angle. Particles that are very small compared to a wavelength tend to scatter as classical dipoles, while those significantly larger than a wavelength scatter mostly into forward angles. Below a certain particle size, therefore, the increased fraction of scattering angle will be greater than the critical angle and some of the light will be lost resulting in attenuation of the signal. It is preferred that the average diameter of the dielectric particles is larger than the wavelength of the transmission signal. For optical transmission wavelengths of 1.55 microns, 1.3 microns, 850 nm, 600 nm, or 520 nm, the average diameter of the dielectric particles of the invention is approximately 1 to about 20 microns, as measured by well known particle measuring techniques such as scanning electron microscopy or laser diffraction. For particles that are essentially spherical in the waveguide core, the average diameter of the particles is preferably about 2 to about 10 microns. Elongated particles are preferably about 10 to 100 nanometers in diameter, and about 100 microns to 20 millimeters in length.

In order to combat signal attenuation which may be caused, for example, by scattering beyond the critical angle as discussed above or by signal absorption or Raleigh scattering by the core medium, the optical waveguides of the invention can optionally be doped with a signal amplification species such as a fluorescent compound. Doping of a conventional fiber optical core (that does not contain scattering elements) with a fluorescent compound to provide signal amplification is well known in the art. For example, erbium doped fiber amplification (EDFA) is know to yield signal amplification in conventional fibers.

The optical waveguides of the invention can be doped with a fluorescent compound in different ways. For an optical fiber, for example, the core itself of the fiber can be doped, the dielectric particles can be doped, or composite particles of the dopant (and any gain material as discussed below) with silica can be added to the core independent of the scattering dielectric particles. One advantage of doping the scattering dielectric particles themselves with the fluorescent compound is that the gain automatically enhances the effect of the scattering and problems normally associated with doping the core, such as increased signal attenuation, are minimized. Preferably, the concentration of fluorescent compound present in the core or the dielectric particles is up to about 2% by weight (based on the weight of the core material).

Examples of dopants that can be used in this aspect of the invention include lanthanide compounds. Preferred dopant compounds are erbium, which emits at approximately 1.525 to 1.565 microns (C-band) and 1.570 to 1.625 microns (L-band), thulium, which emits at approximately 1.48 to 1.51 microns (S-band), ytterbium (1.075 to 1.1 micron band). Preferably, the lanthanide species is introduced into the core or dielectric particle as a composite, e.g., SiO₂:La₂O₃, where La represents a lanthanide with a transition in the appropriate wavelength band for the signal being enhanced. For example, if the lanthanide compound is Er₂O₃, doping of the dielectric particle or core can be achieved by dissolving the erbium composite in the dielectric particle or core during manufacture of the dielectric particle or core. Alternatively, the composite can be co-deposited independently of the dielectric particles so that the radial variation of the concentration of the dielectric particles and the optical gain material can be independently controlled.

Lanthanide-based optical amplification can be further enhanced by the addition of efficiency enhancer or energy transfer species. Suitable enhancer compounds generally absorb pump power more effectively than fluorescent compounds and provide a mechanism for resonant energy transfer to the lanthanide which provides amplification. In essence, enhancer material functions by capturing the pump photons from the pumping energy source and holding the excitation without radiating, and then transferring the excitation to the lanthanide. By placing the enhancer material in close proximity to the fluorescent compound, energy transfer to the fluorescent compound is significantly more efficient than occurs in the absence of enhancer material. Because of this enhanced efficiency, less fluorescent compound is required to provide signal amplification. An efficiency enhancer commonly used with erbium is ytterbium.

Further efficiency increases can be provided by using materials that prevent the fluorescent compound from clustering in the core. Clustered fluorescent molecules, such as erbium oxide, absorb pump power but de-excite rapidly by non-radiative means resulting in lower pump efficiency. The addition of de-clustering species, therefore, can increase pump efficiency. Suitable de-clustering species include bismuth oxide and aluminum oxide.

Further pumping efficiency can be provided by the addition of europium to erbium doped fiber, as is well known in the art. Erbium is efficiently pumped near 900 and 1400 nanometers. However, the excitation from the energetic 900 nanomenter photons is much larger than needed, and the high-lying state which is first populated must then decay to the relevant metastable state which forms the population inversion for the optical amplifier. However, the high-lying state has significant branching ratios to other states, most of which are not metastable and do not lead to increased efficiency. The presence of europium encourages decay from the high-lying state to the metastable state by resonantly absorbing the correct energy from the erbium atom such that the resulting state is long-lived and results in optical amplification.

Distribution and Concentration of Particles

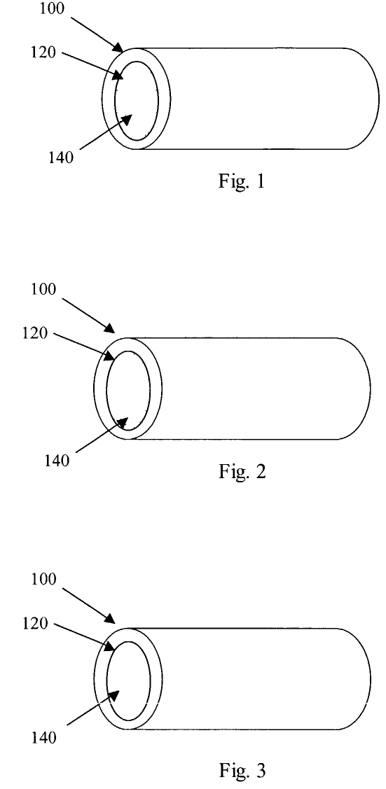

The scattering elements or particles, fluorescent particles and enhancer particles used in the various aspects and embodiments of the invention can be distributed in the waveguide core in a variety of ways and in a variety of concentrations, depending on the desired signal scattering and amplification effects.

Where the primary goal of scattering is reduction in modal dispersion, the dielectric particles can be placed in a continuous, slowly varying radial distribution within the core. This is schematically depicted in FIG. 1, which shows a fiber having a cladding 100, a core 120 and dielectric particles 140 dispersed in the core. By placing particles in a continuously varying distribution, a photon traveling through the core encounters dielectric particles randomly and thus samples a number of modes during its transmission and its velocity is averaged. An ensemble of photons thus averaged then collapses into a narrower distribution of arrival times than if they propagated in each mode undisturbed.

Instead of a continuously varying distribution, the dielectric particles can be concentrated in certain narrow radial regions of the core to either enhance a modal population state or depopulate a modal state. For example, a larger concentration of particles with concentration peaked at the edge of the core (FIG. 2) can selectively depopulate the higher order modes and either transfer the light to lower order modes or out into the cladding. Since higher order modes have much more intensity near the edge of the core than lower order modes, this distribution is selective for the higher order modes. For similar reasons, a concentration of particles at the center of the core (FIG. 3) is more likely to interact with lower order modes.

The number of particles used per unit volume of core affects both the extent of modal mixing and the overall attenuation of the signal. The greater the concentration of particles the larger the modal mixing. However, a greater concentration of particles may also result in larger signal attenuation by out scattering. Therefore, a concentration of particles that results in maximum acceptable attenuation and thus maximum mode mixing is preferred.

The number of particles per unit volume of core material can easily be calculated based on the size of the particle, the effective scattering length (which is the average distance that light travels between scatterings within a specific range of parameters), and the range in angle of forward scattering desired. These calculations are within the knowledge of the person of ordinary skill in the art.

As an example, for a particle size of about 8.5 microns, a difference in refractive index between particle and medium of about 5%, an effective scattering length of about 85 meters for scatterings of 8 degrees or less (12 scatterings per kilometer of fiber), and signal wavelength of 1.5 microns, the particle density (number of particles per cm³ of core material) is approximately 20. More generally, the preferred concentration of particles having a diameter range of about 2 to about 10 microns is about 10 to about 20,000 particles per cm³ of core material.

Incorporation into Waveguide Core

The particles used in the invention can be incorporated into the core by a variety of techniques that are well known in the art. A few examples of incorporation techniques are illustrated below.

If the glass core is made by flame hydrolysis deposition (FHD) or plasma chemical vapor deposition (PCVD), then the particles can be co-deposited as the thickness of the core is built up during the deposition. The radial distribution of the particles is controlled by the ratio of the rates of particle deposition and FHD or PCVD deposition as a function of thickness.

If a narrow distribution of particles is desired at the periphery of the core, the core preform can be coated with particles either just before the end of the FHD or PCVD step or after it, substantially as described in U.S. Pat. Nos. 4,486,212 and 3,806,570, which are both herein incorporated by reference in their entirety. A moving flame can be used to soften the particles and insure that they stick. In this example, particles are concentrated at the periphery of the core. If a narrow distribution of fibers at the center of the core is desired, the mandrel can be coated with particles before FHD or PCVD deposition begins.

Particles that soften or melt can be elongated by the fiber drawing process. The degree of elongation can be controlled by the softening temperature of the particles, which in turn affects the viscosity of the particle relative to that of the core material during the fiber drawing process. If the particles introduced into the preform are elongated at the time they are introduced, then the process of drawing the fiber causes the resulting particles to generally orient along the axis of the fiber. If the elongated particles do not soften, then they are elongated along the axis by viscous forces. It the particles do soften, they are then stretched in the direction of the fiber draw, so that the resulting long, thin, elongated structure will be nearly aligned to the fiber axis.

Core materials thus prepared can be inserted into, for example, a molten cladding material by means well known in the art, such as described for instance in U.S. Pat. No. 5,656,058, which is herein incorporated by reference in its entirety. It is contemplated that various modifications may be made to the present invention without departing from the spirit and scope of the invention as defined in the following claims.

I claim:

1. A multimode optical waveguide comprising:
a core;
a cladding layer surrounding the core; and
a plurality of optical scattering elements dispersed in the core.

2. The optical waveguide of claim 1 wherein the core is a glass core or is a polymer core.

3. The optical waveguide of claim 2 wherein the scattering elements are dielectric particles.

4. The optical waveguide of claim 3 wherein the dielectric particles have a similar index of refraction to the core.

5. The optical waveguide of claim 3 wherein the dielectric particles have an index of refraction that differs from the core by ±0.005 to ±1.

6. The optical waveguide of claim 3 wherein the dielectric particles are selected from the group consisting of silica, titania, alumina, zirconia, hafnia, yttria, erbium oxide, ytterbium oxide, glass, Bi₂O₃, CaF₂, CeF₃, Cr₂O₃, Gd₂O₃, LaF₃, MgF₂, Na₃AlF₆, Sb₂O₃, SrF₂, Ta₂O₅, Y₂O₃, YbF₃, ZnSe, and mixtures thereof.

7. The optical waveguide of claim 3 wherein the dielectric particles are elongated in structure.

8. The optical waveguide of claim 3 wherein the dielectric particles are substantially spherical.

9. The optical waveguide of claim 3 wherein the particles are approximately 2-10 microns in average diameter.

10. The optical waveguide of claim 3 wherein the particles are distributed in a continuous slowly varying radial distribution within the core.

11. The optical waveguide of claim 3 wherein the particles are peripherally concentrated in the core.

12. The optical waveguide of claim 3 wherein the particles are centrally concentrated in the core.

13. The optical waveguide of claim 3 wherein the particles are inter-diffused in the core.

14. The optical waveguide of claim 3 further comprising a signal amplification species.

15. The optical waveguide of claim 14 wherein the signal amplification species is doped in the dielectric particles.

16. The optical waveguide of claim 14 wherein the signal amplification species is a fluorescent compound.

17. The optical waveguide of claim 16 wherein the fluorescent compound is a lanthanide compound.

18. The optical waveguide of claim 14 further comprising an efficiency enhancer species.

19. The optical waveguide of claim 18 wherein the efficiency enhancer species is doped in the dielectric particles.

20. The optical waveguide of claim 18 wherein the efficiency enhancer species is ytterbium or europium.

21. The optical waveguide of claim 14 further comprising a de-clustering species.

22. The optical waveguide of claim 21 wherein the de-clustering species is doped in the dielectric particles.

23. The optical waveguide of claim 21 wherein the de-clustering species is bismuth oxide or aluminum oxide.

24. The optical waveguide of claim 2 wherein the core has a graded index profile.

25. The optical waveguide of claim 24 wherein the scattering elements are dielectric particles with essentially the same refractive index as the core and wherein scattering results from the induced deviation of the graded index profile by the particles.

26. The optical waveguide of claim 2 wherein the scattering elements are or contain photochromic compounds.

27. The optical waveguide of claim 2 wherein the scattering elements are or contain photo-refractive materials.
